(19) United States
(12) Patent Application Publication
(10) Pub. No.: US 2026/0124621 A1
(43) Pub. Date: May 7, 2026

(54) ULTRAFINE PULVERIZATION SYSTEM FOR RHIZOME TRADITIONAL CHINESE MEDICINE

(71) Applicant: QINGDAO UNIVERSITY OF TECHNOLOGY, Shandong (CN)

(72) Inventors: Changhe LI, Shandong (CN); Leyi WANG, Shandong (CN); Mingzheng LIU, Shandong (CN); Kang LI, Shandong (CN); Xiaoming WANG, Shandong (CN); Teng GAO, Shandong (CN); Xiangdong LIU, Shandong (CN); Huayang ZHAO, Shandong (CN); Benkai LI, Shandong (CN); Xiaowei ZHANG, Shandong (CN); Bingheng LU, Shandong (CN)

(73) Assignee: QINGDAO UNIVERSITY OF TECHNOLOGY, Shandong (CN)

(21) Appl. No.: 18/038,991

(22) PCT Filed: Nov. 21, 2022
(86) PCT No.: PCT/CN2022/133289

§ 371 Date: May 13, 2025

(30) Foreign Application Priority Data
Oct. 9, 2022 (CN) 202211227481.0

(51) Int. Cl. B02C 21/00; B02C 13/06; B02C 13/18; B02C 13/28; B02C 13/284; B02C 13/286; B02C 23/16

(52) U.S. Cl. CPC B02C 21/00; B02C 13/06; B02C 13/18; B02C 13/2804; B02C 13/284; B02C 23/16; B02C 2013/28654; B02C 2023/165

(57) ABSTRACT

Provided is an ultrafine pulverization system for rhizome traditional Chinese medicine (TCM), relating to the technical field of TCM processing, and comprising a coarse pulverizer and a fine-ultrafine pulverizer, a feeding elevator is provided on one side of the coarse pulverizer, and a screw feeder is provided between the coarse pulverizer and the fine-ultrafine pulverizer; the coarse pulverizer includes a coarse pulverization base and a coarse pulverization upper housing, the coarse pulverization rotor is provided in a coarse pulverization blade assembly; the coarse pulverization rotor is connected to a first driving mechanism; and the fine-ultrafine pulverizer includes a fine pulverization device, a pneumatic classification device, and an ultrafine pulverization device being provided in turn from top to bottom, an annular air bag is provided outside the ultrafine pulverization device, the fine pulverization device and the ultrafine pulverization device are communicated with each other through a number of blanking channels.

This application claims priority benefits to Chinese Patent Application No. 202211227481.0, filed 9 Oct. 2022, the contents of which are incorporated herein by reference.

### TECHNICAL FIELD

The present invention relates to the technical field of traditional Chinese medicine (TCM) processing, and in particular to an ultrafine pulverization system for rhizome TCM.

### RELATED ART

For the pulverization of rhizome TCM, due to the main component of the rhizome being plant fiber, which has the characteristics of greater toughness, less brittleness, and large strain energy absorbed by the material, it is difficult to pulverize. Moreover, due to the need to reduce the agglomeration of materials during pulverization, it is necessary to dry the TCM before pulverization, which results in a strong tenacity of the rhizome TCM, making it even more difficult to pulverize. In the field of TCM pulverization, most of the existing pulverization equipment is used to pulverize TCM, and reasonable pulverization methods and processes are not selected based on the different types and characteristics of TCM.

At present, the pulverization method of TCM can be roughly divided into mechanical impact pulverization, pulverization medium pulverization and airflow pulverization, wherein the mechanical impact pulverization is to pulverize TCM by a high-speed rotating hammer head or blades driven by an electric motor, of which the pulverization efficiency is high, pulverization ratio is large, and the structure is simple, but most of the impact pulverizers mainly use two force fields of impact and friction to pulverize, more suitable for brittle TCM, but low efficiency of pulverizing the rhizome TCM because the shear force field is the most effective force field for the pulverization of the rhizome TCM with high toughness; in addition, the mechanical impact pulverization can usually pulverize the material to about 100 mesh (150 μm) at most, and need to consume a lot of energy and time to pulverize the material to more details; However, after a large number of studies and experiments, it has been found that most TCM need to be pulverized to a particle size of 70 μm or less, a wall-breaking can be achieved.

The most commonly used equipment in the pulverization medium pulverization is the vibration mill, which uses high intensity vibration to make the material in a mill tube by high acceleration of impact, milling, etc., can pulverize tough materials, and a pulverization particle size thereof can reach 5 μm or less, to meet the requirements of the wall-breaking of the rhizome TCM; however, the mill tube and pulverization medium of the pulverization medium pulverizer will produce greater wear in the pulverization process, causing greater pollution to TCM, and cannot timely isolate the TCM ultrafine powder that has reached the fineness requirements, resulting in excessive pulverization and massive agglomeration of the TCM ultrafine powder.

Airflow pulverization uses the supersonic and highly turbulent airflow generated by compressed air or superheated steam passing through the nozzle as the carrier of particles, causing actions of impact compression, friction, and shearing between particles or between particles and the fixed plate, thereby achieving the purpose of pulverization, of which a particle size of the product can reach 1-10 μm, a range of the particle size distribution is narrow, and the pulverization temperature is low because the gas expands at the nozzle to reduce the temperature; however, the airflow pulverization has high requirements for the feed particle size, and the general particle size cannot be greater than 5 mm. Therefore, before carrying out the airflow pulverization, it is necessary to pre-pulverize the material, and the typical equipment for airflow pulverization can be divided into disk airflow pulverizer, circulating tube airflow pulverizer, target airflow pulverizer, and fluidized bed opposed airflow pulverizer. Wherein, the fluidized bed opposed airflow pulverizer is the most commonly used, which uses multiple high-pressure airflows to carry material particles for high-speed movement, achieving collisions between particles, and make the particles in a fluidized state in the pulverizing room. After the particles have repeatedly collided to meet the fineness requirements, the particles that meet the standards are separated by a classification device; however, this type of pulverizer is more suitable for pulverizing fragile TCM, which consumes a large amount of energy for the pulverization of rhizome TCM; the target airflow pulverizer is to carry out pulverization through collisions between a fixed target plate and the particles carried by a high-speed airflow, and a pulverizing ability thereof is the highest among several types of pulverizers, with high efficiency, which can pulverize tough rhizome TCM, but the fixed target plate is prone to wear, resulting in pollution of TCM.

### SUMMARY

In view of the deficiencies of the prior art, it is an object of the present invention to provide an ultrafine pulverization system for rhizome TCM, which can carry out a coarse pulverization, a fine pulverization, an ultrafine pulverization, a classification and a collection in turn for the rhizome TCM, and finally obtain wall-breaking ultrafine powder of the rhizome TCM, improving the pulverization efficiency of the rhizome TCM and the quality of wall-breaking ultrafine powder.

To achieve the above purpose, the present invention is realized by the following technical solutions:
An example of the present invention provides an ultrafine pulverization system for rhizome TCM, including a coarse pulverizer and a fine-ultrafine pulverizer, a feeding elevator is provided on one side of the coarse pulverizer, and a screw feeder is provided between the coarse pulverizer and the fine-ultrafine pulverizer.

The coarse pulverizer includes a coarse pulverization base and a coarse pulverization upper housing, an installation space for a coarse pulverization rotor is formed by interiors of the coarse pulverization base and the coarse pulverization upper housing, the coarse pulverization rotor is provided in a coarse pulverization blade assembly, and a coarse pulverization screen mesh is provided under a low side of the coarse pulverization rotor; the coarse pulverization rotor is connected to a first driving mechanism.

The fine-ultrafine pulverizer includes a fine pulverization device, a pneumatic classification device, and an ultrafine pulverization device being provided in turn from top to bottom, an annular air bag is provided outside the ultrafine pulverization device, the fine pulverization device and the ultrafine pulverization device are communicated with each other through a number of blanking channels.

As a further implementation, the coarse pulverization rotor includes a coarse pulverization spindle, a plurality of coarse pulverization first blades are mounted on the coarse pulverization spindle through a coarse pulverization blade mounting base.

Coarse pulverization second blades are mounted symmetrically on a side of the coarse pulverization blade assembly towards the coarse pulverization rotor.

As a further implementation, a plurality of the coarse pulverization blade mounting bases are provided in intervals along an axial direction of the coarse pulverization spindle, and a plurality of mounting sections are evenly provided in a circumferential direction of the coarse pulverization blade mounting bases, and the mounting sections corresponding to each the coarse pulverization blade mounting base are connected to the coarse pulverization first blades.

As a further implementation, the coarse pulverization blade assembly includes a coarse pulverization blade mounting bracket, coarse pulverization liner plates are detachably mounted on both sides of the coarse pulverization blade mounting bracket, the coarse pulverization second blades are mounted inside the coarse pulverization blade mounting bracket, and the coarse pulverization second blades extend axially along the coarse pulverization spindle.

As a further implementation, the coarse pulverization blade assembly is a semi-encircled structure, both ends thereof against protruding platforms on an inner wall of the coarse pulverization base; the coarse pulverization screen mesh is detachably connected to the protruding platforms.

As a further implementation, the fine pulverization device includes a fine pulverization housing and a fine pulverization upper cover plate mounted on a top of the fine pulverization housing, a fine pulverization rotor is mounted in the fine pulverization housing, and is connected to a second driving mechanism.

The fine pulverization rotor includes a fine pulverization rotating shaft, a stationary blade mechanism and a movable blade mechanism that are connected to the fine pulverization rotating shaft.

As a further implementation, the fine pulverization housing is a double-layer structure, grooves are formed on a side wall of an inner layer of the fine pulverization housing at intervals, and fine pulverization screen meshes are provided in the grooves; cleaning ports are provided at positions on an outer layer structure of the fine pulverization housing corresponding to the fine pulverization screen meshes, and the cleaning ports are communicated with the blanking channels.

As a further implementation, the fine pulverization screen mesh includes a fine pulverization first screen mesh, and a fine pulverization second screen mesh provided on an outside of the fine pulverization first screen mesh, an aperture of the fine pulverization first screen mesh is larger than an aperture of the fine pulverization second screen mesh.

As a further implementation, the stationary blade mechanism includes a fine pulverization blade fixed disc and fine pulverization stationary blades, the fine pulverization blade fixed disc is fixedly connected to the fine pulverization rotating shaft; a plurality of pin bars with edges and corners are provided along a circumference of an upper surface of the fine pulverization blade fixed disc, and a plurality of the fine pulverization stationary blades are uniformly distributed along a circumferential direction of the fine pulverization blade fixed disc.

As a further implementation, the movable blade mechanism includes a movable blade upper cover plate, fine pulverization movable blades, and a movable blade lower cover plate, the movable blade upper cover plate and the movable blade lower cover plate are mounted in turn on the fine pulverization rotating shaft; a plurality of the fine pulverization movable blades are mounted between the movable blade upper cover plate and the movable blade lower cover plate, and the fine pulverization movable blades are fitted with cylindrical bulges on the movable blade lower cover plate.

As a further implementation, the ultrafine pulverization device includes an ultrafine pulverization housing, a plurality of fine powder feeding channels are uniformly provided on a circumferential direction of the ultrafine pulverization housing, an air inlet duct is provided below each the fine powder feeding channel along the circumference, a Laval nozzle is provided in each the air inlet duct, and an air inlet end of the Laval nozzle is connected to the annular air bag.

As a further implementation, an ultrafine pulverization support base is mounted at a bottom of the ultrafine pulverization housing, an ultrafine pulverization rotating shaft is provided on the ultrafine pulverization support base, and a rotating target is provided on an outer side of the ultrafine pulverization rotating shaft; the ultrafine pulverization rotating shaft is connected to a third driving mechanism.

A surface of the rotating target is provided with a number of bulges.

As a further implementation, the pneumatic classification device includes a classification device support housing, a negative pressure guide chamber is provided inside the classification device support housing, and one side of the negative pressure guide chamber is connected to a ventilation pipe.

A classification rotating shaft is mounted inside the negative pressure guide chamber, and a classification wheel is connected to a bottom of the classification rotating shaft.

As a further implementation, the classification wheel includes a classification wheel upper cover plate, classification blades, a classification wheel lower cover plate, and a diffusion cone, one end of the classification blade is connected to the classification wheel upper cover plate, an opposite end thereof is connected to the classification wheel lower cover plate, the diffusion cone is mounted in a lower side of the classification wheel lower cover plate.

As a further implementation, the system further includes a cyclone separator, a pulse dust collector and an induced draft fan that are sequentially connected, and the cyclone separator is connected to one side of the fine-ultrafine pulverizer.

The beneficial effects of the present invention are as follows:
(1) According to the present invention, the pulverization of rhizome TCM has been divided into three stages of coarse pulverization, fine pulverization and ultrafine pulverization by setting the coarse pulverizer and fine-ultrafine pulverizer, which gives full play to the advantages of different pulverization methods and improves the pulverization efficiency.
(2) According to the present invention, the coarse pulverizer performs coarse pulverization based on shear force according to the characteristics of rhizome TCM, and the coarse pulverization blade assembly provided with a plurality of groups of blades and liner plates, so that the coarse pulverization rotor can shear and impact the TCM for a plurality of times every rotation, and the pulverizing efficiency is high.
(3) According to the present invention, the fine-ultrafine pulverizer integrates fine pulverization, ultrafine pulverization and classification, has compact structure and greatly reduces the occupied area; the blanking channels are arranged between the fine pulverization device and the ultrafine pulverization device, so that the TCM fine powder pulverized in the fine pulverization device can rapidly fall into the ultrafine pulverization device for ultrafine pulverization through the blanking channels under the action of gravity and negative pressure in the ultrafine pulverization device, and a large amount of agglomeration of the TCM fine powder is avoided.
(4) According to the present invention, the fine pulverization device is equipped with the stationary blade mechanism and the movable blade mechanism, which can strongly shear, grind and impact collision on the TCM particles with high pulverization efficiency; the setting of two layers of screen meshes ensures that the particle size of the TCM fine powder can reach the feeding particle size requirement of the airflow ultrafine pulverization of TCM.
(5) According to the present invention, the ultrafine pulverization device uses supersonic airflow to drive the TCM to impact the rotating target, which has strong pulverization capacity and can make the TCM fine powder further pulverized into TCM wall-breaking ultrafine powder; the design of the rotating target can better rub and shear the TCM, and avoid the problem that the traditional target airflow pulverization only impacts a point of the fixed target and causes serious wear on the target surface; the ultrafine pulverization device has a plurality of fine powder feeding channels, and a Laval nozzle is provided under each the fine powder feeding channel, so that the TCM fine powder entering the ultrafine pulverization device can be accelerated at a potential energy core zone of the airflow ejected from the Laval nozzle, which ensures that the TCM fine powder impacts the rotating target with sufficient kinetic energy.
(6) According to the present invention, the pneumatic classification device can quickly classify the TCM ultrafine powder with the particle size up to the standard, and the classifying particle size can be controlled; the classification wheel is equipped with the diffusion cone, which can make the TCM ultrafine powder dispersed so as to classify the TCM more effectively.
(7) In the present invention, the fragile parts (blade, liner plate, rotating target, classification blade) are all detachably connected and easy to replace, and wear-resistant materials are chosen to prevent the pollution to TCM caused by massive wear.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a general assembly view according to one or more examples of the present invention;

FIG. 2 is an isometric view of a coarse pulverizer according to one or more examples of the present invention;

FIG. 3(a) is an isometric view of a pulverization portion of the coarse pulverizer according to one or more examples of the present invention;

FIG. 3(b) is a main view of the pulverization portion of the coarse pulverizer according to one or more examples of the present invention;

FIG. 3(c) is a cross-sectional view of an A-A interface in FIG. 3(b);

FIG. 3(d) is an exploded view of the pulverization portion of the coarse pulverizer according to one or more examples of the present invention;

FIG. 4(a) is a main view of a coarse pulverizer rotor according to one or more examples of the present invention;

FIG. 4(b) is a cross-sectional view of an A-A interface in FIG. 4(a);

FIG. 5 is an exploded view of a coarse pulverization blade assembly according to one or more examples of the present invention;

FIG. 6 is an isometric view of a fine-ultrafine pulverizer according to one or more examples of the present invention;

FIG. 7 is a side view of the fine-ultrafine pulverizer according to one or more examples of the present invention;

FIG. 8 is a cross-sectional view of a main body of the fine-ultrafine pulverizer according to one or more examples of the present invention;

FIG. 9(a) is a partially enlarged view at a-position in FIG. 8;

FIG. 9(b) is a partially enlarged view at b-position in FIG. 8;

FIG. 9(c) is a partially enlarged view at c-position in FIG. 8;

FIG. 10 is an isometric view of a fine pulverization device of the fine-ultrafine pulverizer according to one or more examples of the present invention;

FIG. 11 is an isometric view of an interior of the fine pulverization device of the fine-ultrafine pulverizer according to one or more examples of the present invention;

FIG. 12 is a top view of a fine pulverization housing according to one or more examples of the present invention.

FIG. 13 is an exploded view of a fine pulverization rotor according to one or more examples of the present invention;

FIG. 14 is an axonometric partial sectional view of an ultrafine pulverization device of the fine-ultrafine pulverizer according to one or more examples of the present invention;

FIG. 15 is a schematic diagram of a mounting position of a Laval nozzle according to one or more examples of the present invention;

FIG. 16 is a schematic diagram of an internal structure of the Laval nozzle according to one or more examples of the present invention;

FIG. 17 is a schematic view of a flow field distribution of a jet stream of single the Laval nozzle according to one or more examples of the present invention;

FIG. 18 is an axonometric partial sectional view of a pneumatic classification device of the fine-ultrafine pulverizer according to one or more examples of the present invention;

FIG. 19 is an exploded view of a classification wheel according to one or more examples of the present invention;

FIG. 20 is a schematic view of a force exerted on TCM ultrafine powder at the classification wheel according to one or more examples of the present invention.
wherein, I feeding elevator, II coarse pulverizer, III screw feeder, IV fine-ultrafine pulverizer, V cyclone separator, VI pulse dust collector, VII induced draft fan;
II-1 coarse pulverization motor, II-2 coarse pulverization upper housing, II-3 coarse pulverization base. II-4 coarse pulverization support bracket, II-5 coarse pulverization discharge hopper, II-6 bearing with base, II-7 coarse pulverization large pulley, II-8 coarse pulverization small pulley, II-9 coarse pulverization rotor, II-10 coarse pulverization blade assembly, II-11 coarse pulverization screen mesh, II-9-1 coarse pulverization spindle, II-9-2 coarse pulverization blade mounting base, II-9-3 coarse pulverization first blade, II-9-4 lock nut, II-9-5 sleeve, II-10-1 coarse pulverization blade mounting bracket, II-10-2 coarse pulverization liner plate, II-10-3 coarse pulverization second blade;
IV-1 fine pulverization motor, IV-2 fine-ultrafine pulverization support bracket, IV-3 fine pulverization device, IV-4 pneumatic classification device, IV-5 ultrafine pulverization device, IV-6 annular air bag, IV-7 blanking channel, IV-8 ultrafine pulverization motor, IV-9 pneumatic classification motor, IV-3-1 fine pulverization feeding hopper, IV-3-2 fine pulverization pulley, IV-3-3 fine pulverization upper cover plate, IV-3-4 upper bearing assembly, IV-3-5 sealing cover plate, IV-3-6 fine pulverization housing, IV-3-7 fine pulverization rotor, IV-3-8 fine pulverization liner plate, IV-3-9 fine pulverization first screen mesh, IV-3-10 fine pulverization second screen mesh, IV-3-11 lower bearing assembly, IV-4-1 classification device support housing, IV-4-2 classification pulley, IV-4-3 classification bearing assembly, IV-4-4 ventilation pipe, IV-4-5 negative pressure guide chamber, IV-4-6 classification wheel, IV-4-7 classification rotating shaft, IV-5-1 ultrafine pulverization housing, IV-5-2 Laval nozzle, IV-5-3 ultrafine pulverization support base, IV-5-4 rotating target, IV-5-5 ultrafine pulverization pulley, IV-5-6 ultrafine pulverization bearing assembly, IV-5-7 ultrafine pulverization rotating shaft; and
IV-3-7-1 fine pulverization first sleeve, IV-3-7-2 movable blade upper cover plate, IV-3-7-3 fine pulverization movable blade, IV-3-7-4 movable blade lower cover plate, IV-3-7-5 fine pulverization second sleeve, IV-3-7-6 fine pulverization blade fixed disc. IV-3-7-7 fine pulverization stationary blade, IV-3-7-8 fine pulverization rotating shaft, IV-4-6-1 classification wheel upper cover plate, IV-4-6-2 classification blade, IV-4-6-3 classification wheel lower cover plate, IV-4-6-4 diffusion cone.

### DESCRIPTION OF THE EMBODIMENTS

### Example 1

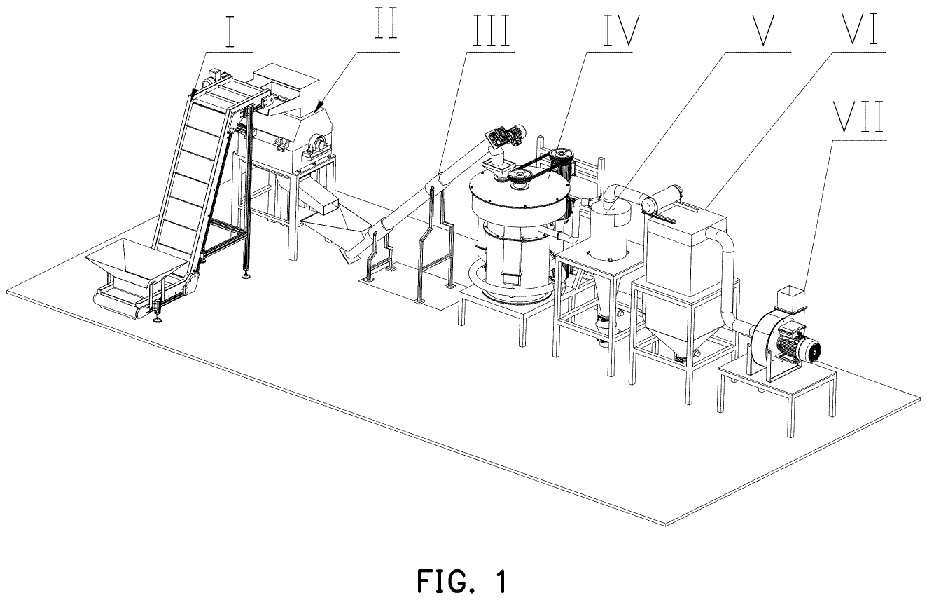

The present example provides an ultrafine pulverization system for rhizome TCM, as shown in FIG. 1, including a feeding elevator I, a coarse pulverizer II, a screw feeder III, fine-ultrafine pulverizer IV, a cyclone separator V, a pulse dust collector VI and an induced draft fan VII; wherein, the feeding elevator I is provided on one side of the coarse pulverizer II, the screw feeder III is provided between the coarse pulverizer II and the fine-ultrafine pulverizer IV; the cyclone separator V, the pulse dust collector VI and the induced draft fan VII are provided in turn on one side of the fine-ultrafine pulverizer IV and connected in turn through pipes.

The feeding elevator I is used to transport the dried large pieces of sliced or cut rhizome TCM (referred to as large pieces of TCM) to the coarse pulverizer II; the coarse pulverizer II is used to coarsely pulverize the large pieces of TCM into TCM particles; the screw feeder III is used to transport the coarsely pulverized TCM particles to the fine-ultrafine pulverizer IV; the fine-ultrafine pulverizer IV is used to finely pulverize and superfine pulverize the coarsely pulverized rhizome TCM particles into TCM ultrafine powder, and pneumatically classify the TCM ultrafine powder, and separate out the TCM ultrafine powder that has reached the fineness requirement in time; the cyclone separator V is used to collect the TCM ultrafine powder that has reached the fineness requirement separated from the fine-ultrafine pulverizer IV; the pulse dust collector VI is used to collect again a very small portion of the TCM ultrafine powder flowing from the cyclone separator, and prevent air pollution; the induced draft fan VII is connected to the pulse dust collector VI, and is used to provide a negative pressure suction required in the process of classification and collection.

The cyclone separator V and the pulse dust collector VI are all made of existing technology and will not be described here.

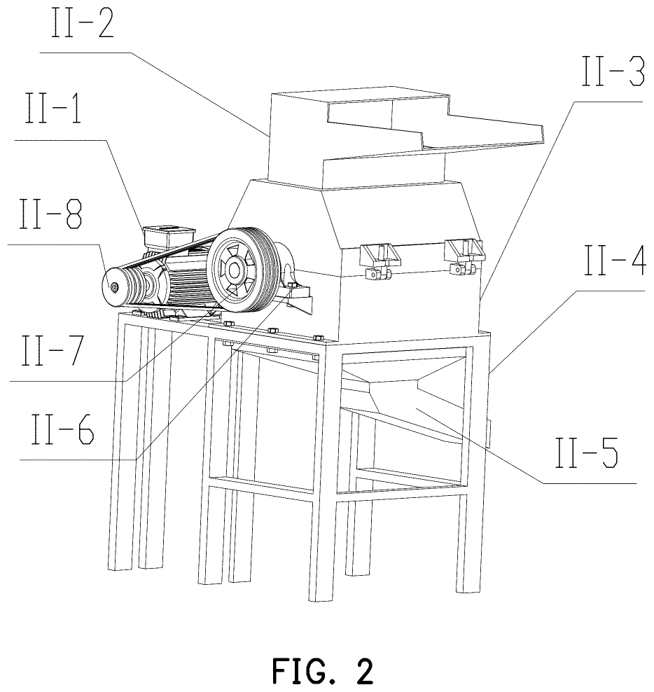

As shown in FIG. 2, the coarse pulverizer II includes a coarse pulverization support bracket II-4, a coarse pulverization upper housing II-2, a coarse pulverization base II-3, a coarse pulverization rotor II-9, rotor driving mechanism, etc. The coarse pulverization base II-3 is fixed on an upper side of the coarse pulverization support bracket II-4 by bolts, the coarse pulverization upper housing II-2 is connected to an upper side of the coarse pulverization base II-3, and a mounting room for the coarse pulverization rotor II-9 is formed inside the coarse pulverization base II-3 and the coarse pulverization upper housing II-2. The coarse pulverization discharge hopper II-5 is provided at a bottom of the coarse pulverization base II-3, and an inlet is provided at a top of the coarse pulverization upper housing II-2.

In the present example, the rotor driving mechanism uses a pulley driving mechanism, and the pulley driving mechanism and the coarse pulverization motor II-1 constitute a first driving mechanism. The pulley driving mechanism includes a coarse pulverization large pulley II-7 and a coarse pulverization small pulley II-8, wherein the coarse pulverization large pulley II-7 is connected to the coarse pulverization rotor II-9, and is connected to the coarse pulverization small pulley II-8 by a synchronous belt, the coarse pulverization small pulley II-8 is mounted on a motor shaft of the coarse pulverization motor II-1, the coarse pulverization motor II-1 is fixed to the coarse pulverization support bracket II-4, and the coarse pulverization small pulley II-8 is driven by the coarse pulverization motor II-1, so that the coarse pulverization large pulley II-7 may drive the coarse pulverization rotor II-9 to rotate.

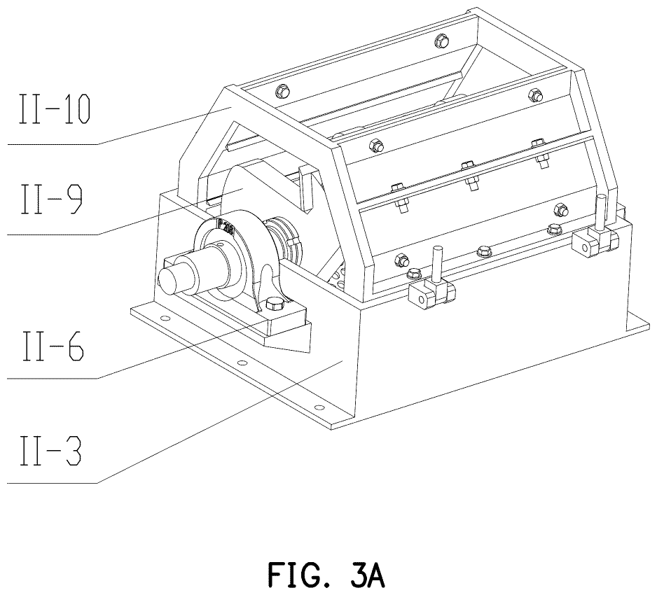

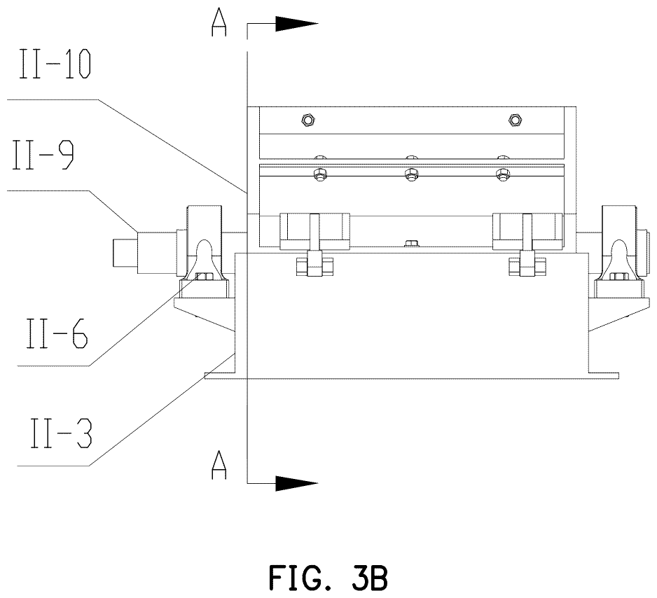

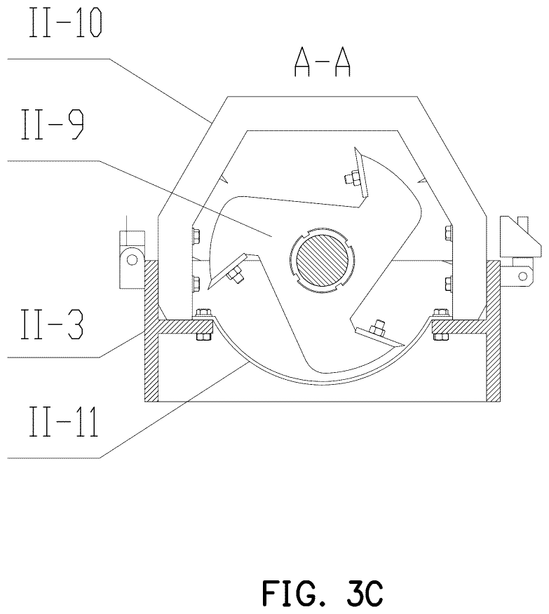

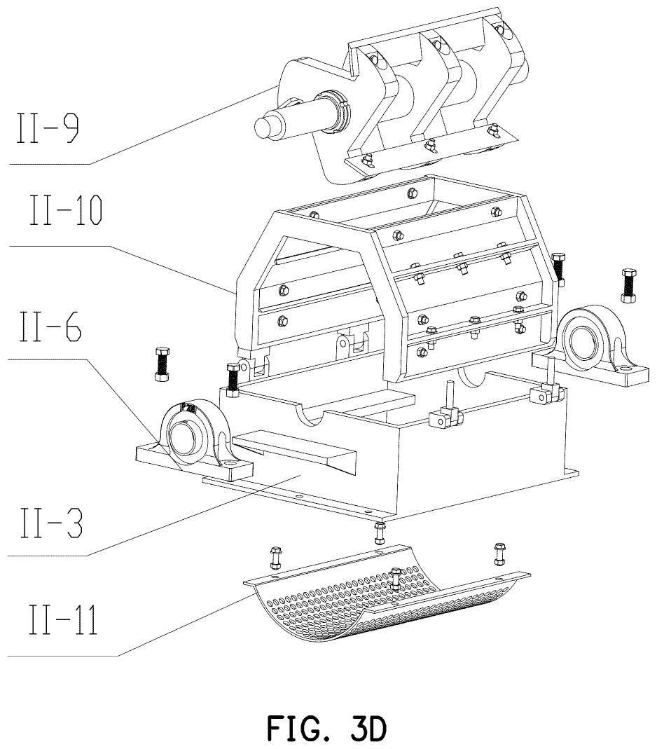

As shown in FIGS. 3(a) and 3(b), lug bosses are provided at both ends of the coarse pulverization base II-3, bearings with bases II-6 are fixed to the lug bosses by bolts, and the bearings with bases II-6 are connected to both ends of the coarse pulverization rotor II-9, respectively. As shown in FIG. 3(c) and FIG. 3(d), a coarse pulverization blade assembly II-10 and a coarse pulverization screen mesh II-11 are mounted to an outer side of the coarse pulverization rotor II-9, and a cross-sectional shape of the coarse pulverization screen mesh II-11 has a circular arc shape and protrudes downward; an axial direction of the coarse pulverization screen mesh II-11 is aligned with an axial direction of the coarse pulverization rotor II-9.

Two protruding platforms are symmetrically provided on an inner wall of the coarse pulverization base II-3, and the coarse pulverization screen mesh II-11 is connected between the two protruding platforms by bolts, the coarse pulverization screen mesh II-11 is located on a lower side of the coarse pulverization rotor II-9 and has a certain distance from the coarse pulverization rotor II-9. The coarse pulverization blade assembly II-10 is also provided between the two protruding platforms and is connected to an inner wall of the coarse pulverization base II-3 by bolts, and a cross-sectional shape of the coarse pulverization blade assembly II-10 is a semi-enveloping structural shape.

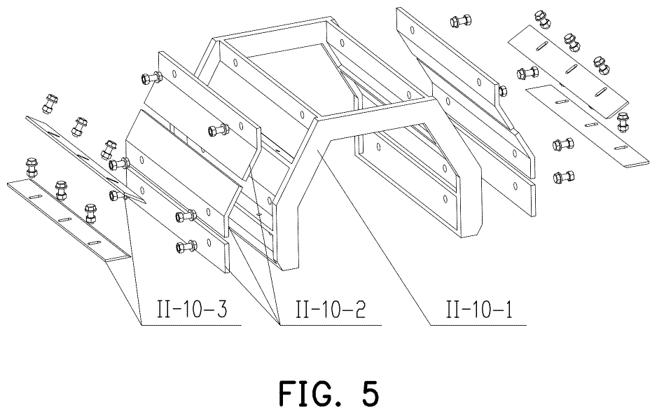

As shown in FIG. 5, the coarse pulverization blade assembly II-10 includes a coarse pulverization blade mounting bracket II-10-1, coarse pulverization liner plates II-10-2, and coarse pulverization second blades II-10-3, wherein the coarse pulverization liner plates II-10-2 are symmetrically mounted on both sides of the coarse pulverization blade mounting bracket II-10-1, and a top and a bottom of the coarse pulverization blade mounting bracket II-10-1 are open structures, and the opening at the bottom is larger than the opening at the top.

A number of the coarse pulverization second blades II-10-3 are symmetrically mounted on an inside of the coarse pulverization blade mounting bracket II-10-1, such as one, two or more, the number of which is provided according to the actual situation. In the present example, the coarse pulverization second blade II-10-3 is a rectangular blade whose length extends along an axis of the coarse pulverization rotor II-9, and the coarse pulverization second blade II-10-3 protrudes from an inner side of the coarse pulverization liner plate II-10-2 to cooperate with the coarse pulverization rotor II-9 to pulverize the rhizome TCM.

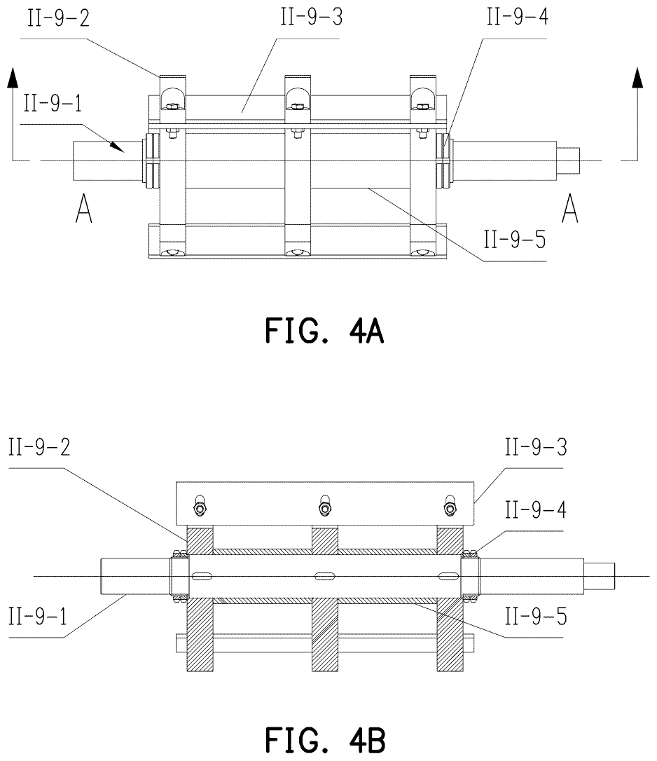

As shown in FIGS. 4(a) and 4(b), the coarse pulverization rotor II-9 includes a coarse pulverization spindle II-9-1, a coarse pulverization blade mounting base II-9-2 and coarse pulverization first blades II-9-3, wherein the coarse pulverization blade mounting base II-9-2 is mounted on the coarse pulverization spindle II-9-1 through a coarse pulverization sleeve II-9-5, the coarse pulverization sleeve II-9-5 is coaxial with the coarse pulverization spindle II-9-1 and is connected to the coarse pulverization spindle II-9-1 by coarse pulverization lock nuts II-9-4; the coarse pulverization first blades II-9-3 are mounted on the coarse pulverization blade mounting base II-9-2.

As shown in FIGS. 3(c) and 3(d), a plurality of the coarse pulverization blade mounting bases II-9-2 are provided in intervals along an axial direction of the coarse pulverization spindle II-9-1, for example, the number is three, and a plurality of mounting sections are evenly provided in a circumferential direction of each the coarse pulverization blade mounting base II-9-2, and the mounting sections corresponding to each the coarse pulverization blade mounting base II-9-2 are connected to the coarse pulverization first blades II-9-3. In the present example, the coarse pulverization blade mounting bases II-9-2 are formed similar to a vane structure by the mounting sections.

The coarse pulverization first blades II-9-3 are distributed circumferentially around the coarse pulverization spindle II-9-1 at an acute angle to a radial direction of the mounted position, and working surfaces (cutting surfaces) of the blades are distributed counterclockwise so that the coarse pulverization first blades II-9-3 cut rhizome TCM by rotating around the coarse pulverization spindle II-9-1.

In the present example, three the mounting sections are circumferentially provided on the coarse pulverization blade mounting base II-9-2, and one side of the mounting section is a mounting surface, and the coarse pulverization first blade II-9-3 is fitted with the mounting surface, and three the coarse pulverization first blades II-9-3 are mounted through the coarse pulverization blade mounting base II-9-2.

An inlet is provided on the coarse pulverization upper housing II-2, and the large pieces of TCM transported by the feeding elevator I fall to an inside of the coarse pulverization base II-3 through the inlet on the coarse pulverization upper housing II-2; the coarse pulverization motor II-1 drives the coarse pulverization rotor II-9 to rotate through the synchronous belt, and the coarse pulverization first blades II-9-3 move as well; when the coarse pulverization first blades II-9-3 move to positions of the coarse pulverization second blades II-10-3, the coarse pulverization first blades II-9-3 and the coarse pulverization second blades II-10-3 cooperate to strongly shear the large pieces of TCM, and the coarse pulverization rotor II-9 may provide a lot of kinetic energy to the TCM in the process of rotation, so that the large pieces of TCM may strongly collide and impact the coarse pulverization liner plates II-10-2; then, the large pieces of TCM are continuously pulverized into TCM particles under the action of the shear force and the impact force, and the TCM particles may pass through the coarse pulverization screen mesh II-11 when they are smaller than a mesh size of the coarse pulverization screen mesh II-11, and be discharged by the coarse pulverization discharge hopper II-5 and transported by the screw feeder III to the fine-ultrafine pulverizer IV for the next pulverization. Because the pulverization ratio in coarse pulverization should not be too large, otherwise the energy consumption will increase sharply, in the present example, the mesh size of the coarse pulverization screen mesh II-11 is provided in 1-3 cm.

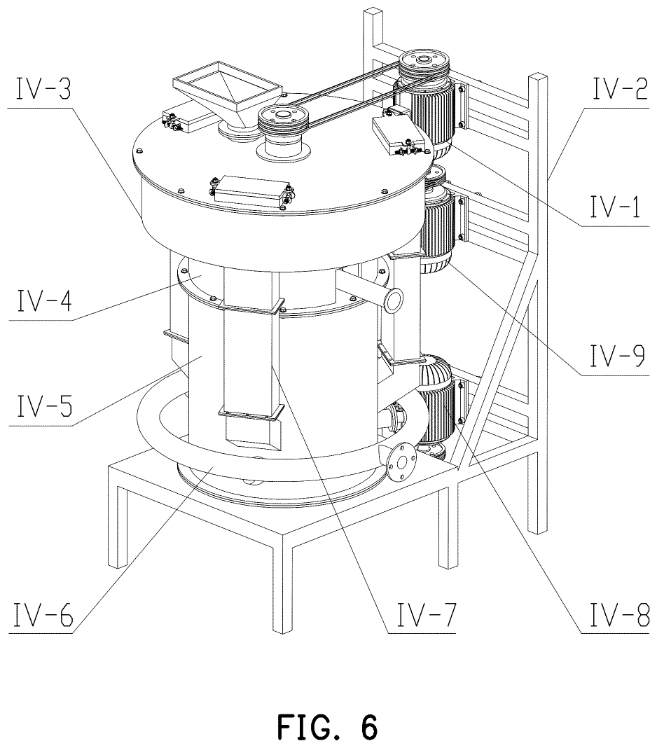

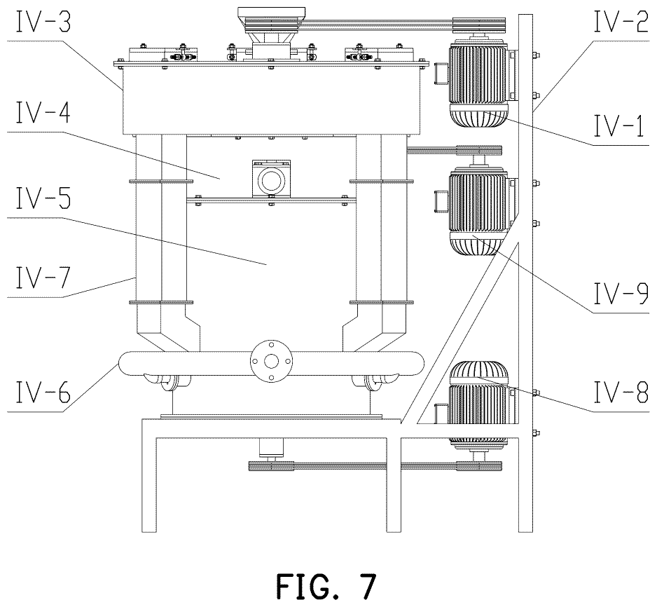

As shown in FIGS. 6 and 7, the fine-ultrafine pulverizer IV includes a fine-ultrafine pulverization support bracket IV-2, a main body of the fine-ultrafine pulverizer mounted on the fine-ultrafine pulverization support bracket IV-2, the main body of the fine-ultrafine pulverizer includes a fine pulverization device IV-3, an ultrafine pulverization device IV-5, a pneumatic classification device IV-4, an annular air bag IV-6 and a blanking channel IV-7. The ultrafine pulverization device IV-5 is fixed with the fine-ultrafine pulverization support bracket IV-2, a top of the ultrafine pulverization device IV-5 is connected to the fine pulverization device IV-3 through the pneumatic classification device IV-4; one side of the fine pulverization device IV-3 is connected to the blanking channel IV-7, and the annular air bag IV-6 is provided around the ultrafine pulverization device IV-5.

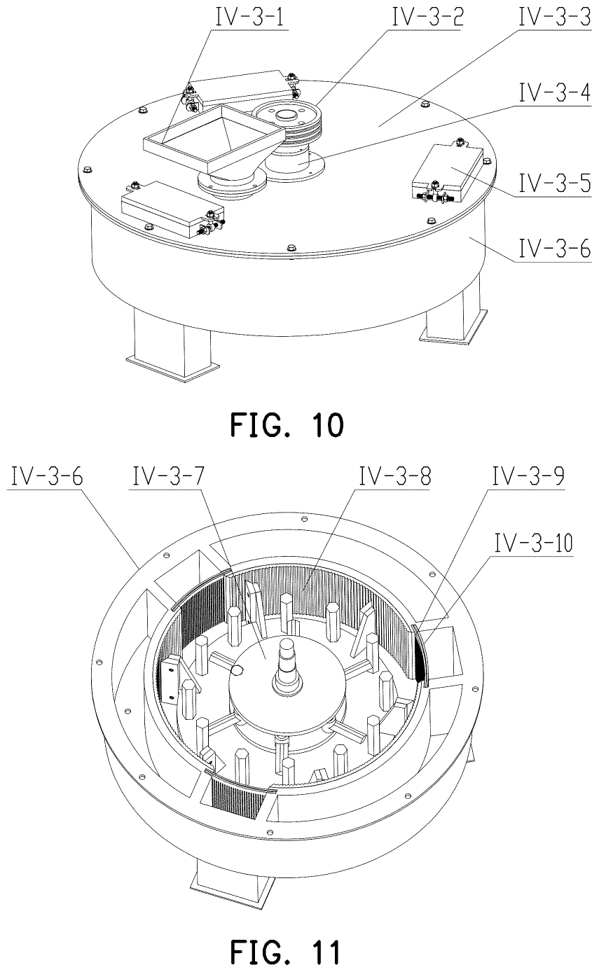

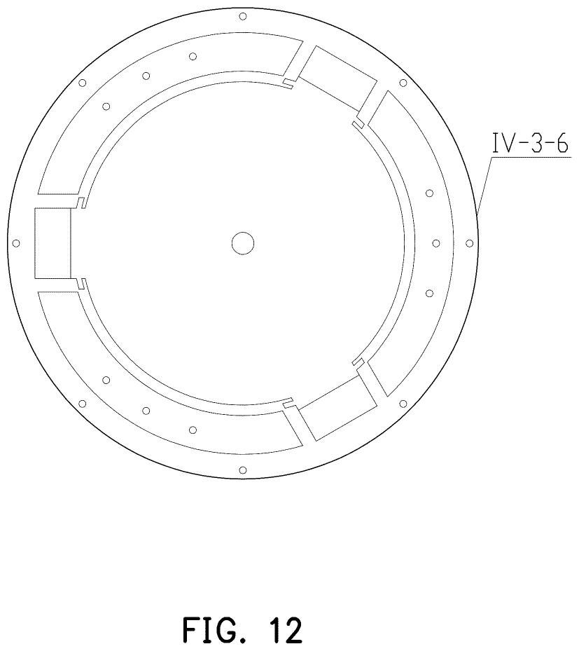

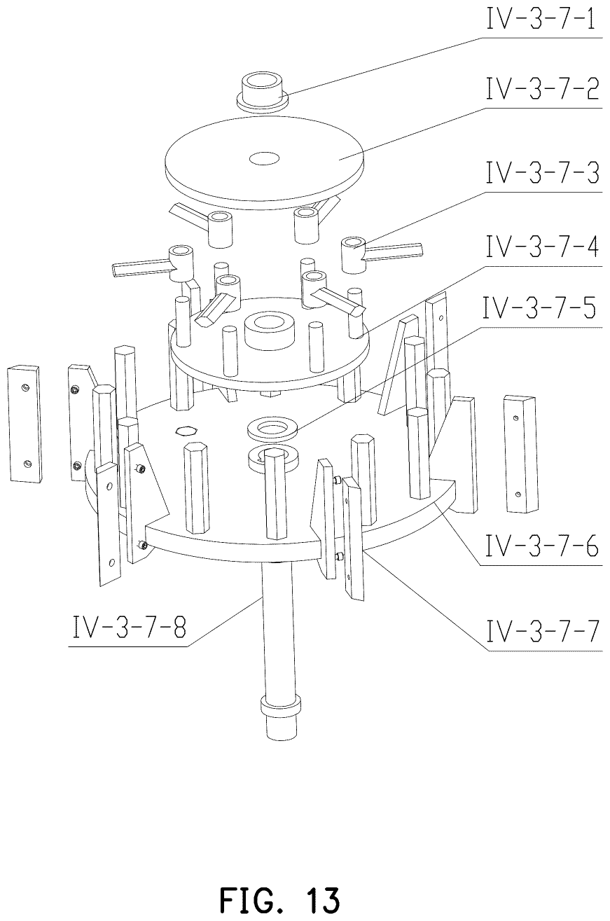

As shown in FIGS. 10-13, the fine pulverization device IV-3 includes a fine pulverization housing IV-3-6, a top of the fine pulverization housing IV-3-6 is connected to a fine pulverization upper cover plate IV-3-3 by bolts, a cleaning port and a fine pulverization inlet are provided on the fine pulverization upper cover plate IV-3-3; the cleaning port corresponds to an outer side of the fine pulverization screen mesh, and multiple thereof are provided at intervals along an edge of the fine pulverization upper cover plate IV-3-3, such as three; a fine pulverization feeding hopper IV-3-1 is provided at the position of the fine pulverization inlet. The cleaning port is detachably connected to a sealing cover plate IV-3-5, the sealing cover plate IV-3-5 is used for sealing during pulverization to prevent the TCM particles from flying out of the cleaning port, and can be opened to facilitate cleaning and replacing the fine pulverization screen mesh below the cleaning port, and to clean an inside of the fine pulverization housing IV-3-6 and the blanking channel IV-7.

The fine pulverization housing IV-3-6 is cylindrical, and has an internal mounting cavity; the mounting cavity is divided into an inner layer and an outer layer; a plurality of grooves are opened at intervals on a side wall of the inner layer of the cavity, the fine pulverization screen meshes are provided in the grooves, the fine pulverization liner plates IV-3-8 are connected to the side wall of the inner layer of the cavity by bolts and arranged at intervals with the fine pulverization screen meshes. The fine pulverization liner plates IV-3-8 are made of wear-resistant materials (e.g. corundum or carbide) and are provided with serrated bulges on surfaces thereof. In the present example, the grooves are provided for three, and the side wall of the inner layer of the cavity is divided into three equal parts by the three grooves.
wherein, the fine pulverization screen mesh is provided with two layers, that is, a fine pulverization first screen mesh IV-3-9 and a fine pulverization second screen mesh IV-3-10, and the fine pulverization first screen mesh IV-3-9 and the fine pulverization second screen mesh IV-3-10 are inserted in the grooves. Each the groove corresponds to the cleaning port. The outer layer of the cavity is divided into three arc-shaped areas by the cleaning ports. The fine pulverization first screen mesh IV-3-9 closes to an inner side of the fine pulverization second screen mesh IV-3-10, and a mesh size of the fine pulverization first screen mesh IV-3-9 is larger than that of the fine pulverization second screen mesh IV-3-10, because the cost increases as the mesh size of the screen mesh becomes smaller, and the mesh of the screen mesh becomes more easily damaged, so that the fine pulverization first screen mesh IV-3-9 may play a protective effect on the fine pulverization second screen mesh IV-3-10, and the fine pulverization second screen mesh IV-3-10 plays a role in controlling the particle size. Combined with the requirements of particle size of the airflow pulverization, in the present example, the mesh size of the fine pulverization first screen mesh IV-3-9 is provided in a range of 2-5 mm, and the mesh size of the fine pulverization second screen mesh IV-3-10 is provided in 2 mm or less.

Three fine powder discharge channels are evenly provided along a circumference below the fine pulverization housing IV-3-6, and the fine powder discharge channels correspond to the cleaning ports one by one, and a bottom end of the fine powder discharge channel is connected to the blanking channel IV-7 by bolts.

A fine pulverization rotor IV-3-7, of which an axial direction is provided along a vertical direction, is mounted at a center of the fine pulverization housing IV-3-6; a top end of the fine pulverization rotor IV-3-7 is connected to the fine pulverization motor IV-1 through a pulley driving mechanism, and the fine pulverization motor IV-1 and the pulley driving mechanism constitute a second driving mechanism; the fine pulverization rotor IV-3-7 is driven to rotate by the fine pulverization motor IV-1. The pulley driving mechanism is located on the outside of the fine pulverization upper cover plate IV-3-3, and the fine pulverization motor IV-1 is fixed with the fine pulverization support bracket IV-2.

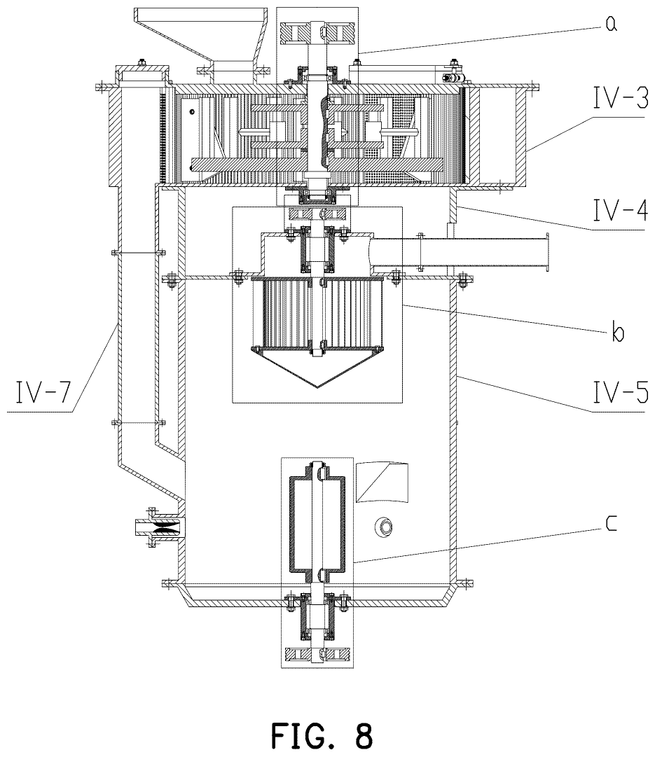

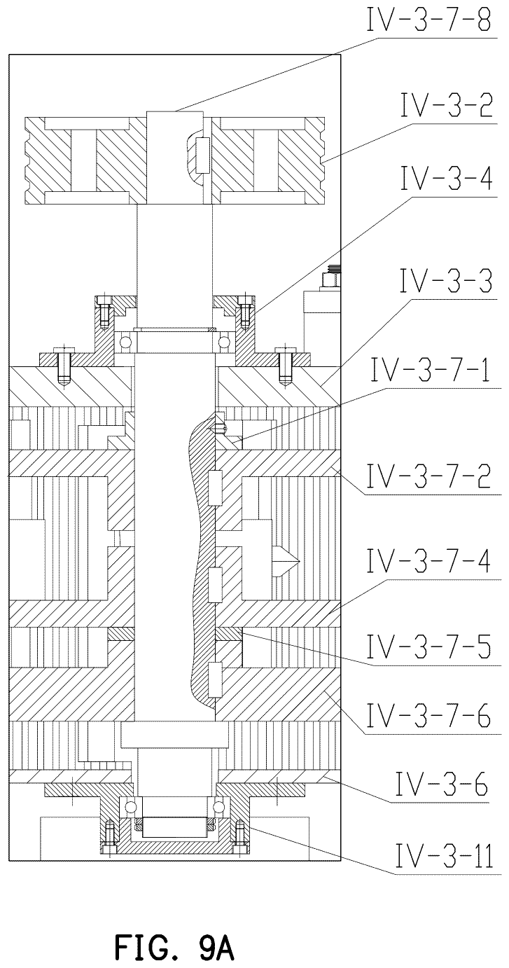

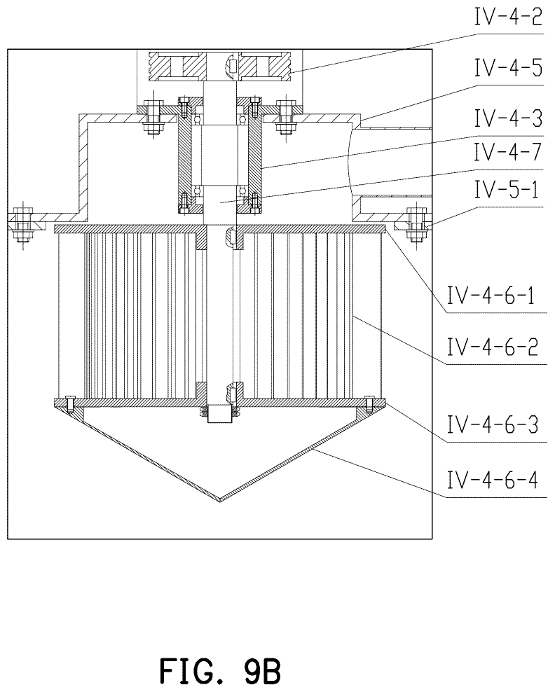

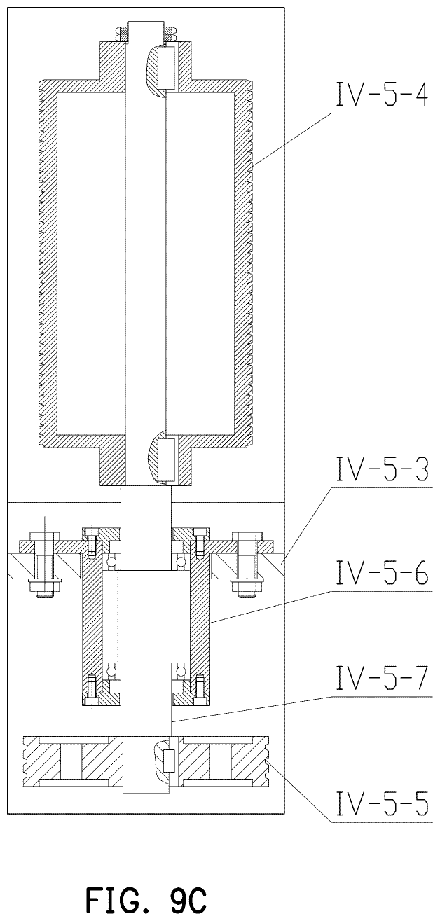

As shown in FIGS. 8, 9(a) and 13, the fine pulverization rotor IV-3-7 includes a fine pulverization rotating shaft IV-3-7-8 and a stationary blade mechanism and a movable blade mechanism connected to the fine pulverization rotating shaft IV-3-7-8, a top end of the fine pulverization rotating shaft IV-3-7-8 is connected to an upper bearing assembly IV-3-4, a bottom end of the fine pulverization rotating shaft IV-3-7-8 is connected to a lower bearing assembly IV-3-11, and the fine pulverization rotating shaft IV-3-7-8 is connected to a fine pulverization pulley IV-3-2 by a key.

The stationary blade mechanism includes a fine pulverization blade fixed disc IV-3-7-6 and fine pulverization stationary blades IV-3-7-7, the fine pulverization blade fixed disc IV-3-7-6 is fixedly connected to the fine pulverization rotating shaft IV-3-7-8, and the fine pulverization blade fixed disc IV-3-7-6 is axially fixed to a shoulder of the fine pulverization rotating shaft IV-3-7-8 through a fine pulverization second sleeve IV-3-7-5 and circumferentially fixed through keys. As shown in FIG. 11, a plurality of pin bars with edges and corners are provided along a circumference of the position close to that edge of an upper surface of the fine pulverization blade fixed disc IV-3-7-6, and the pin bars perpendicular to the fine pulverization blade fixed disc IV-3-7-6; the fine pulverization stationary blade IV-3-7-7 is connected to the fine pulverization blade fixed disc IV-3-7-6 by bolt, and a plurality of the fine pulverization stationary blades IV-3-7-7 are uniformly distributed along a circumference of the fine pulverization blade fixed disc IV-3-7-6.

The movable blade mechanism includes a movable blade upper cover plate IV-3-7-2, a fine pulverization movable blade IV-3-7-3 and a movable blade lower cover plate IV-3-7-4, wherein the movable blade upper cover plate IV-3-7-2 and the movable blade lower cover plate IV-3-7-4 are sequentially mounted on the fine pulverization rotating shaft IV-3-7-8, and a certain distance is reserved therebetween for mounting the fine pulverization movable blade IV-3-7-3. A plurality of cylindrical bulges are provided along a circumferential direction of position close to an edge of an upper surface of the movable blade lower cover plate IV-3-7-4, and circular grooves corresponding to the cylindrical bulges one by one are provided along a circumferential direction of the movable blade upper cover plate IV-3-7-2. One end of the fine pulverization movable blade IV-3-7-3 is a hollow cylinder which is sleeved on the cylindrical bulge, achieving an axial limit of the fine pulverization movable blade IV-3-7-3 through the movable blade upper cover plate IV-3-7-2 and the movable blade lower cover plate IV-3-7-4, so that the fine pulverization movable blade can rotate along with the fine pulverization rotating shaft IV-3-7-8. The movable blade mechanism is axially fixed by a fine pulverization second sleeve IV-3-7-5, a fine pulverization first sleeve IV-3-7-1 and set screws, and is circumferentially fixed by keys.

The TCM particles after the coarse pulverization are transported through the screw feeder and dropped from the fine pulverization feeding hopper IV-3-1 to the inside of the fine pulverization housing IV-3-6, the fine pulverization motor IV-1 drives the fine pulverization rotor IV-3-7 to rotate through the synchronous belt, and the fine pulverization movable blade IV-3-7-3 first strongly shears and splits the TCM particles and gives the TCM particles a great kinetic energy, making the TCM particles collide and impact the pin rods arranged along the circumference of the fine pulverization blade fixed disc IV-3-7-6; after that, the TCM particles are thrown to the fine pulverization liner plate IV-3-8 under the action of centrifugal force, which the fine pulverization stationary blade IV-3-7-7 cooperates with to fully grind and shear the TCM particles, so that the particle size of the TCM particles gradually become smaller and thus be pulverized into TCM fine powder; when the particle size of the TCM fine powder is smaller than the mesh size of the fine pulverization second screen mesh IV-3-10, the TCM fine powder pass through the fine pulverization screen mesh and flow out through the fine pulverization blanking channel IV-7, and fall through the blanking channel IV-7 into the ultrafine pulverization housing IV-5-1 of the ultrafine pulverization device IV-5 for ultrafine pulverization. Since the fine pulverization movable blade IV-3-7-3 and the fine pulverization stationary blade IV-3-7-7 are detachable connected, it is convenient to replace the blades when they become worn.

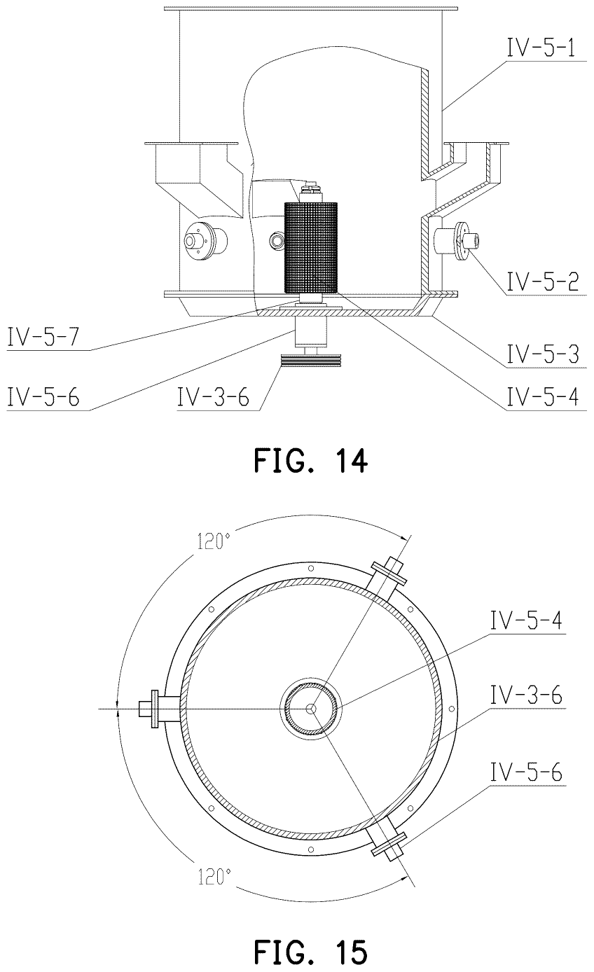

As shown in FIGS. 8, 9(c), 14 and 15, the ultrafine pulverization device IV-5 includes an ultrafine pulverization housing IV-5-1, a plurality of fine powder feeding channels are uniformly provided on a circumferential direction of the ultrafine pulverization housing IV-5-1 and connected to the blanking channels IV-7 by bolts; an air inlet duct is provided along a circumference below each the fine powder feeding channel, central axes of all the air inlet ducts are located on the same horizontal plane; a Laval nozzle IV-5-2 is provided in each the air inlet duct and connected to the air inlet duct by bolts, and an air inlet end of the Laval nozzle IV-5-2 is connected to the annular air bag IV-6, and central axes of all the Laval nozzle IV-5-2 are also on the same horizontal plane and intersect at a central point. In the present example, the Laval nozzles IV-5-2 are provided for three, and an included angle between axes thereof is 120°.

The ultrafine pulverization support base IV-5-3 is mounted at a bottom of the ultrafine pulverization housing IV-5-1, and an ultrafine pulverization bearing assembly IV-5-6 is connected to a center position of the ultrafine pulverization support base IV-5-3 by bolts and connected to the ultrafine pulverization rotating shaft IV-5-7; the ultrafine pulverization rotating shaft IV-5-7 is coaxially provided with the ultrafine pulverization housing IV-5-1.

A rotating target IV-5-4, which is made of wear-resistant material (corundum or carbide), is fixed on the ultrafine pulverization rotating shaft IV-5-7, wherein the rotating target IV-5-4 is of a cylindrical structure, and a surface of the rotary target IV-5-4 is provided with a plurality of bulges, so that the TCM fine powder can be fully sheared and rubbed in the rotating process of the rotating target IV-5-4. Because the rotating target IV-5-4 rotates continuously, the problem of serious target body abrasion caused by only impacting one point of the fixed target in the traditional target airflow pulverization is avoided; and the rotating target IV-5-4 is detachably connected to the ultrafine pulverization rotating shaft IV-5-7 for convenient replacement thereof.

An ultrafine pulverization pulley IV-5-5 is connected to a lower end of the ultrafine pulverization rotating shaft IV-5-7 by a key, and is connected to a pulley on a motor shaft of the ultrafine pulverization motor IV-8 by a synchronous belt; the ultrafine pulverization motor IV-8 and the corresponding pulley driving mechanism constitute a third driving mechanism. The ultrafine pulverization motor IV-8 drives the ultrafine pulverization rotating shaft IV-5-7 to rotate through the synchronous belt, and the rotating target IV-5-4 also rotates, and the finely pulverized TCM fine powder enters an interior of the ultrafine pulverization housing IV-5-1 through the fine powder feeding channel provided in the ultrafine pulverization housing IV-5-1, and the airflow emitted by the plurality of the Laval nozzles IV-5-2 makes the TCM fine powder fluidize in the interior of the ultrafine pulverization housing IV-5-1. The airflow carries TCM fine powder for high-speed movement, causing multiple collisions, shearing, and friction between the TCM fine powder and between the TCM fine powder and the rotating target, further crushing the TCM fine powder into the TCM ultrafine powder.

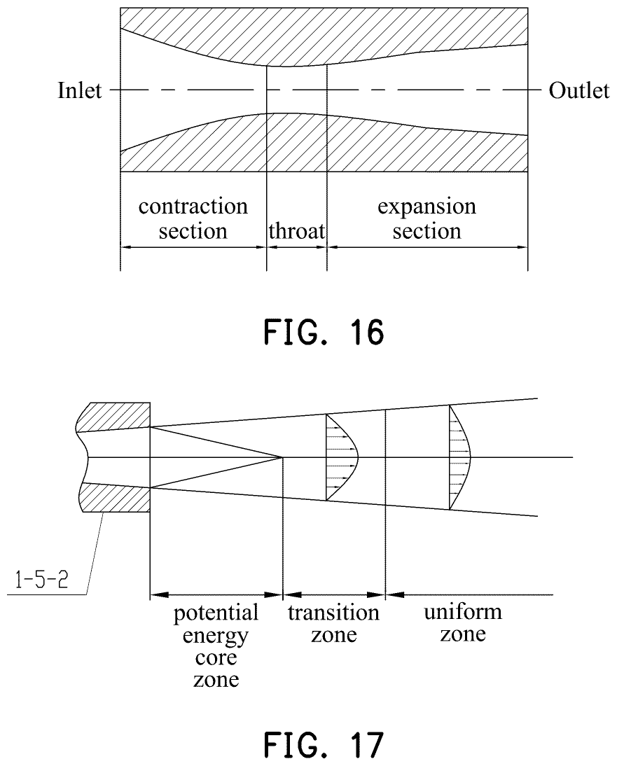

As shown in FIGS. 16 and 17, an interior of the Laval nozzle IV-5-2 is in a shape of contraction and expansion, which can be divided into a contraction section, a throat and an expansion section. A high-pressure airflow is delivered, by an air compressor (not shown in the figure), to an air inlet of the Laval nozzle IV-5-2 through the annular air bag IV-6. Following the principle that the flow velocity increases when the section of fluid moves in the pipe decreases, the cross-sectional area of the airflow becomes smaller when it flows through the contraction section, and the flow velocity of the air gradually increases. When the airflow reaches the throat, the flow velocity of the air can reach a sonic speed. After the airflow reaches the sonic speed, the movement of the fluid no longer follows the principle that the section decreases and the flow velocity increases, but on the contrary, the flow velocity increases when the section increases. so that that flow velocity of the air can further increase when passing through the expansion section to form a supersonic airflow, so that the airflow ejected from an air outlet hole of the Laval nozzle has a great kinetic energy.

A field of the airflow ejected from the single Laval nozzle IV-5-2 can be divided into three parts, which are, respectively, a potential energy core zone near the nozzle, a transition zone adjacent to the potential energy core zone and an uniform zone at the end, wherein the potential energy core zone is the largest part of the kinetic energy of the ejected airflow, the kinetic energy of the airflow in the transition zone and the uniform zone is significantly lower than that in the potential energy core zone, and the kinetic energy of the airflow in the uniform zone is the smallest. In the present example, each the fine powder feeding channel is provided above the discharge port of the corresponding Laval nozzle IV-5-2, so that the TCM fine powder entering inside the ultrafine pulverization housing IV-5-1 can be accelerated in the potential energy core zone, thus ensuring that the TCM fine powder impacts the rotating target IV-5-4 with sufficient kinetic energy.

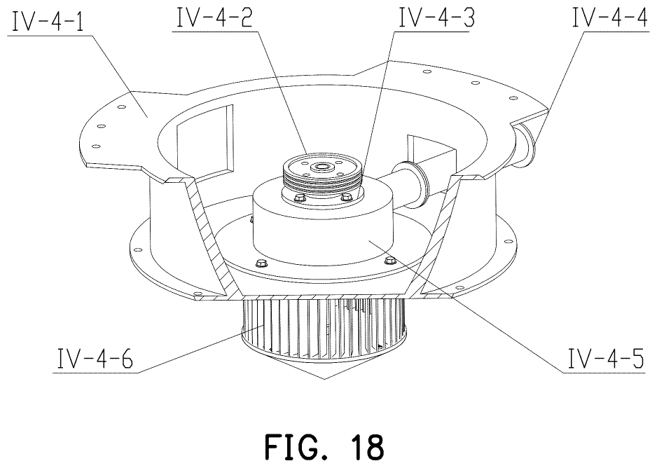

Referring to FIGS. 8, 9(b), 18 and, 19, the pneumatic classification device IV-4 includes a classification device support housing IV-4-1, a top of the classification device support housing IV-4-1 is connected to the fine pulverization housing IV-3-6 by bolts, and a bottom thereof is connected to the ultrafine pulverization housing IV-5-1 by bolts. A negative pressure guide chamber IV-4-5, of which one side is connected to a ventilation pipe IV-4-4 by bolts, is provided inside the classification device support housing IV-4-1.

A classification bearing assembly IV-4-3 is mounted at a top of the negative pressure guide chamber IV-4-5, and a classification rotating shaft IV-4-7 is connected to the classification bearing assembly IV-4-3, and a top of the classification rotating shaft IV-4-7 is connected with the classification pulley IV-4-2 by a key, and a bottom thereof is connected with a classification wheel IV-4-6 by a key and a lock nut.

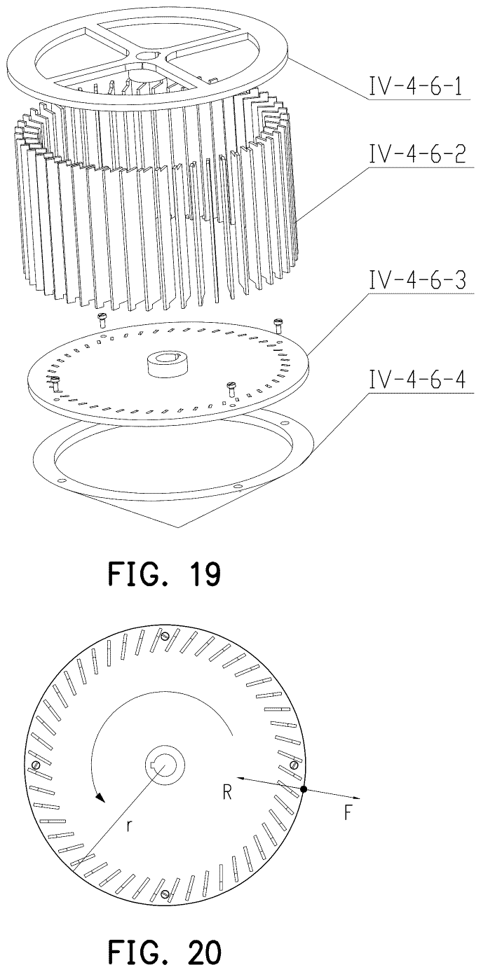

As shown in FIG. 19, the classification wheel IV-4-6 includes a classification wheel upper cover plate IV-4-6-1, a classification blade IV-4-6-2, a classification wheel lower cover plate IV-4-6-3 and a diffusion cone IV-4-6-4, wherein bulges are provided on both ends of the classification blade IV-4-6-2, and corresponding grooves are provided on the classification wheel upper cover plate IV-4-6-1 and the classification wheel lower cover plate IV-4-6-3, which can make the classification blade IV-4-6-2 are fitted together with the classification wheel upper cover plate IV-4-6-1 and the classification wheel lower cover plate IV-4-6-3, and the classification wheel lower cover plate IV-4-6-3 is connected to the diffusion cone IV-4-6-4 by screws.

The classification blade IV-4-6-2 can be made of wear-resistant material (corundum or carbide), and the classification blade IV-4-6-2 is detachably connected for easy replacement. The classification blade IV-4-6-2 will be impacted by the TCM ultrafine powder when classifying the TCM ultrafine powder by the classification wheel IV-4-6.

The classification wheel IV-4-6 rotates under an action of the pulley driving mechanism driven by the pneumatic classification motor IV-9, and under an action of the induced draft fan VII, the air inside the ultrafine pulverization device is continuously sucked away through the negative pressure guide chamber IV-4-5 and the ventilation pipe IV-4-4, so that the negative pressure is formed inside the ultrafine pulverization device, and the TCM ultrafine powder inside the ultrafine pulverization device rises to the classification wheel IV-4-6 with the airflow, at which time the TCM ultrafine powder is not only acted by a centripetal force generated by the induced draft fan VII, but also acted by a centrifugal force generated by a high-speed rotation of the classification wheel IV-4-6, wherein the coarser TCM ultrafine powder is subject to the centrifugal force greater than the centripetal force, and is thrown to an inner wall of the ultrafine pulverization housing IV-5-1, and is pulverized again under an action of gravity and falls along the inner wall, and the finer TCM ultrafine powder is subject to the centripetal force greater than the centrifugal force, so that it can pass through a gap of the classification blade IV-4-6-2 and enter the cyclone separator V and the pulse dust collector VI through the negative pressure guide chamber IV-4-5 and the ventilation pipe IV-4-4 for collection.

As shown in FIG. 20, when the TCM ultrafine powder reaches the bottom of the classification wheel IV-4-6 with the rising airflow, the diffusion cone IV-4-6-4 rotates at high speed, which can make the rising ultrafine powder be evenly dispersed, and the dispersed TCM ultrafine powder continues to rise to an outer edge of a certain cross section of the classification blade IV-4-6-2 and is subject to the centripetal force R generated by the induced draft fan VII and the centrifugal force F generated by the high-speed rotation of the classification wheel IV-4-6. Setting a diameter size of the ultrafine powder to be d, a density to be, a tangential velocity of the rotating flow of the classification wheel to be, a radius of the classification wheel to be r, and a density of the air to be ρ, then the centrifugal force on the ultrafine powder is:

$$F = \frac{π {d}^{3} ( {ρ}_{s} - ρ ) {V}_{t}^{2}}{6 r} \qquad ( 1 )$$

Assuming that the radial velocity of the ultrafine powder at the classification wheel is equal to the radial velocity of the rotational flow of the classification wheel, which is the air viscosity, then the centripetal force on the particles is:

$$R = 3 πμ {V}_{r} d \qquad ( 2 )$$

When the ultrafine powder is coarse, F>R, the ultrafine powder is thrown to the inner wall of the ultrafine pulverization housing IV-5-1, and falls along the inner wall under the action of gravity for pulverization again; when the ultrafine powder is pulverized to meet the particle size requirements, F<R, the qualified TCM ultrafine powder can pass through the gap of the classification blade IV-4-6-2 and enter the cyclone separator V and the pulse dust collector VI through the negative pressure guide camber IV-4-5 and the ventilation pipe IV-4-4 for collection. When the centrifugal force and the centripetal force on the ultrafine powder are equal, i.e. F=R, the ultrafine powder will theoretically rotate around a classification circular orbit with radius r, and the particle size of the ultrafine powder at this time is called the critical particle size, which can be obtained according to Formula (1) and Formula (2):

$${D}_{t} = \frac{1}{{V}_{t}} \sqrt{\frac{18 μ {rV}_{r}}{{ρ}_{s} - ρ}} \qquad ( 3 )$$

The Formula (3) is applicable to a spherical ultrafine powder; however, for a non-spherical ultrafine powder, a shape correction factor needs to be introduced, then obtaining:

$${D}_{t} = \frac{{P}_{s}}{{V}_{t}} \sqrt{\frac{18 μ {rV}_{r}}{{ρ}_{s} - ρ}} \qquad ( 4 )$$

From Formula (4), it can be seen that in order to obtain the ultrafine powder with smaller particle size, it needs to reduce the critical particle size, and under the condition that the size and structure of the classification wheel are determined and the viscosity and the density of air remain unchanged, the larger the tangential speed of the rotating flow of the classification wheel is, the smaller the critical particle size is. Therefore, the TCM ultrafine powder with different particle sizes can be separated by controlling the rotating speed of the classification wheel, and the higher the rotating speed of the classification wheel is, the smaller the particle size of the separated TCM ultrafine powder is.

The foregoing descriptions are merely preferred embodiments of the present invention but are not intended to limit the present invention. A person skilled in art may make various alterations and variations to the present invention. Any modification, equivalent replacement, or improvement made within the spirit and principle of the present invention shall fall within the protection scope of the present invention.

To the claims:

1. An ultrafine pulverization system for rhizome traditional Chinese medicine (TCM), comprising a coarse pulverizer and a fine-ultrafine pulverizer, a feeding elevator is provided on one side of the coarse pulverizer, and a screw feeder is provided between the coarse pulverizer and the fine-ultrafine pulverizer;
the coarse pulverizer includes a coarse pulverization base and a coarse pulverization upper housing, an installation space for a coarse pulverization rotor is formed by interiors of the coarse pulverization base and the coarse pulverization upper housing, the coarse pulverization rotor is provided in a coarse pulverization blade assembly, and a coarse pulverization screen mesh is provided under a low side of the coarse pulverization rotor; the coarse pulverization rotor is connected to a first driving mechanism; and
the fine-ultrafine pulverizer includes a fine pulverization device, a pneumatic classification device, and an ultrafine pulverization device being provided in turn from top to bottom, an annular air bag is provided outside the ultrafine pulverization device, the fine pulverization device and the ultrafine pulverization device are communicated with each other through a number of blanking channels.

2. The ultrafine pulverization system for rhizome TCM according to claim 1, wherein the coarse pulverization rotor includes a coarse pulverization spindle, a plurality of coarse pulverization first blades are mounted on the coarse pulverization spindle through a coarse pulverization blade mounting base;
coarse pulverization second blades are mounted symmetrically on a side of the coarse pulverization blade assembly towards the coarse pulverization rotor.

3. The ultrafine pulverization system for rhizome TCM according to claim 2, wherein a plurality of the coarse pulverization blade mounting bases are provided in intervals along an axial direction of the coarse pulverization spindle, and a plurality of mounting sections are evenly provided in a circumferential direction of the coarse pulverization blade mounting bases, and the mounting sections corresponding to each the coarse pulverization blade mounting base are connected to the coarse pulverization first blades.

4. The ultrafine pulverization system for rhizome TCM according to claim 2, wherein the coarse pulverization blade assembly includes a coarse pulverization blade mounting bracket, coarse pulverization liner plates are detachably mounted on both sides of the coarse pulverization blade mounting bracket, the coarse pulverization second blades are mounted inside the coarse pulverization blade mounting bracket, and the coarse pulverization second blades extend axially along the coarse pulverization spindle.

5. The ultrafine pulverization system for rhizome TCM according to claim 2, wherein the coarse pulverization blade assembly is a semi-encircled structure, both ends thereof against protruding platforms provided on an inner wall of the coarse pulverization base; the coarse pulverization screen mesh is detachably connected to the protruding platforms.

6. The ultrafine pulverization system for rhizome TCM according to claim 1, wherein the fine pulverization device includes a fine pulverization housing and a fine pulverization upper cover plate mounted on a top of the fine pulverization housing, a fine pulverization rotor is mounted in the fine pulverization housing, and is connected to a second driving mechanism;
the fine pulverization rotor includes a fine pulverization rotating shaft, a stationary blade mechanism and a movable blade mechanism that are connected to the fine pulverization rotating shaft.

7. The ultrafine pulverization system for rhizome TCM according to claim 6, wherein the fine pulverization housing is a double-layer structure, grooves are formed on a side wall of an inner layer of the fine pulverization housing at intervals, and fine pulverization screen meshes are provided in the grooves; cleaning ports are provided at positions on an outer layer structure of the fine pulverization housing corresponding to the fine pulverization screen mesh, and the cleaning ports are communicated with the blanking channels.

8. The ultrafine pulverization system for rhizome TCM according to claim 7, wherein the fine pulverization screen mesh includes a fine pulverization first screen mesh, and a fine pulverization second screen mesh provided on an outside of the fine pulverization first screen mesh, an aperture of the fine pulverization first screen mesh is larger than an aperture of the fine pulverization second screen mesh.

9. The ultrafine pulverization system for rhizome TCM according to claim 6, wherein the stationary blade mechanism includes a fine pulverization blade fixed disc and fine pulverization stationary blades, the fine pulverization blade fixed disc is fixedly connected to the fine pulverization rotating shaft; a plurality of pin bars with edges and corners are provided along a circumference of an upper surface of the fine pulverization blade fixed disc, and a plurality of the fine pulverization stationary blades are uniformly distributed along a circumferential direction of the fine pulverization blade fixed disc.

10. The ultrafine pulverization system for rhizome TCM according to claim 6, wherein the movable blade mechanism includes a movable blade upper cover plate, fine pulverization movable blades, and a movable blade lower cover plate, the movable blade upper cover plate and the movable blade lower cover plate are mounted in turn on the fine pulverization rotating shaft; a plurality of the fine pulverization movable blades are mounted between the movable blade upper cover plate and the movable blade lower cover plate, and the fine pulverization movable blades are fitted with cylindrical bulges on the movable blade lower cover plate.

11. The ultrafine pulverization system for rhizome TCM according to claim 1, wherein the ultrafine pulverization device includes an ultrafine pulverization housing, a plurality of fine powder feeding channels are uniformly provided on a circumferential direction of the ultrafine pulverization housing, an air inlet duct is provided below each fine powder feeding channel along a circumference, a Laval nozzle is provided in each the air inlet duct, and an air inlet end of the Laval nozzle is connected to the annular air bag.

12. The ultrafine pulverization system for rhizome TCM according to claim 11, wherein an ultrafine pulverization support base is mounted at a bottom of the ultrafine pulverization housing, an ultrafine pulverization rotating shaft is provided on the ultrafine pulverization support base, and a rotating target is provided on an outer side of the ultrafine pulverization rotating shaft; the ultrafine pulverization rotating shaft is connected to a third driving mechanism;
a surface of the rotating target is provided with a number of bulges.

13. The ultrafine pulverization system for rhizome TCM according to claim 1, wherein the pneumatic classification device includes a classification device support housing, a negative pressure guide chamber is provided inside the classification device support housing, and one side of the negative pressure guide chamber is connected to a ventilation pipe;
a classification rotating shaft is mounted inside the negative pressure guide chamber, and a classification wheel is connected to a bottom of the classification rotating shaft.

14. The ultrafine pulverization system for rhizome TCM according to claim 13, wherein the classification wheel includes a classification wheel upper cover plate, classification blades, a classification wheel lower cover plate, and a diffusion cone, one end of the classification blade is connected to the classification wheel upper cover plate, an opposite end thereof is connected to the classification wheel lower cover plate, the diffusion cone is mounted in a lower side of the classification wheel lower cover plate.

15. The ultrafine pulverization system for rhizome TCM according to claim 1, wherein the system further comprising a cyclone separator, a pulse dust collector and an induced draft fan that are sequentially connected, and the cyclone separator is connected to one side of the fine-ultrafine pulverizer.

16. The ultrafine pulverization system for rhizome TCM according to claim 1, wherein the coarse pulverization blade assembly includes a coarse pulverization blade mounting bracket, coarse pulverization liner plates are detachably mounted on both sides of the coarse pulverization blade mounting bracket, a coarse pulverization second blades are mounted inside the coarse pulverization blade mounting bracket, and the coarse pulverization second blades extend axially along a coarse pulverization spindle.

17. The ultrafine pulverization system for rhizome TCM according to claim 1, wherein the coarse pulverization blade assembly is a semi-encircled structure, both ends thereof against protruding platforms provided on an inner wall of the coarse pulverization base; the coarse pulverization screen mesh is detachably connected to the protruding platforms.

18. The ultrafine pulverization system for rhizome TCM according to claim 1, wherein an ultrafine pulverization support base is mounted at a bottom of a ultrafine pulverization housing, an ultrafine pulverization rotating shaft is provided on the ultrafine pulverization support base, and a rotating target is provided on an outer side of the ultrafine pulverization rotating shaft; the ultrafine pulverization rotating shaft is connected to a third driving mechanism;
a surface of the rotating target is provided with a number of bulges.
